(19) United States
(12) Patent Application Publication
(10) Pub. No.: US 2026/0172440 A1
(43) Pub. Date: Jun. 18, 2026

(54) VULNERABILITY ASSESSMENT WITHIN A NETWORK

(71) Applicant: Superna Inc., Ottawa (CA)

(72) Inventors: Andrew MacKAY, Ottawa (CA); Daniel GANDANEGARA, Singapore (SG)

(73) Assignee: Superna Inc., Ottawa (CA)

(21) Appl. No.: 18/986,534

(22) Filed: Dec. 18, 2024

(51) Int. Cl. H04L 9/40; H04L 41/16

(52) U.S. Cl. CPC H04L 63/1433; H04L 41/16

(57) ABSTRACT

In a computer implemented method of vulnerability assessment within a network, vulnerability assessment data including audit data is received for a plurality of storage devices of a network, the audit data including time series data of access events to the plurality of storage devices, an access event identifying a host device accessing the storage device of the plurality of storage devices, a user identifier of the host device accessing the storage device, and an operation performed by the host device during the access of the storage device. The vulnerability assessment data is evaluated to predict host devices and user identifiers of the network demonstrating a risk of vulnerability to stored data of the plurality of storage devices. A list is generated of the host devices and the user identifiers of the network demonstrating a risk of vulnerability to the stored data of the plurality of storage devices of the network.

### BACKGROUND

To combat unauthorized access to computer networks, enterprises employ vulnerability management solutions to identify vulnerabilities in a network. Conventional vulnerability management solutions typically take a device-centric approach to vulnerability analysis. Host devices of a network are identified and analyzed for security vulnerabilities, and an ordered list of devices ranked according to risk is generated. Using this ordered list of devices, remediation of the riskiest devices can be undertaken, e.g., by updating and patching software on the host devices. However, these conventional solutions typically only perform vulnerability assessments based on host devices, and do not consider other factors, such as users of these host devices or access to network stored data using these host devices.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating an example network including a vulnerability assessment tool, in accordance with various embodiments.

FIG. 2 is a block diagram illustrating a vulnerability assessment tool, in accordance with various embodiments.

FIG. 3 is a block diagram illustrating an example data collector, in accordance with various embodiments.

FIG. 4 is a block diagram illustrating a data preprocessing module of a vulnerability assessment tool, in accordance with various embodiments.

FIG. 5 is a block diagram illustrating a data evaluation module of a vulnerability assessment tool, in accordance with various embodiments.

FIG. 6 is a block diagram of an example computer system upon which embodiments of the present invention can be implemented.

FIG. 7 is a flow diagram for a process of vulnerability assessment within a network, according to various embodiments.

FIGS. 8A, 8B, 8C, and 8D are flow diagrams for processes for determining various types of vulnerability assessment data, according to various embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “evaluating,” “generating,” “labelling,” “weighting,” “inputting,” “predicting,” “training,” “performing,” “mapping,” “determining,” sampling,” “classifying,” or the like, refer to the actions and processes of an electronic computing device or system such as: a host device, a host processor, a processor, a memory, a cloud-computing environment, a network attached storage (NAS) device, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may include random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve the performance of computer network vulnerability assessment and remediation. In various embodiments, a computer-implemented method of vulnerability assessment within a network is provided. Vulnerability assessment data including audit data is received for a plurality of storage devices of a network, the audit data including time series data of accesses to the plurality of storage devices, an access identifying a host device accessing the storage device of the plurality of storage devices, a user identifier of the host device accessing the storage device, and an operation performed by the host device during the access of the storage device. The vulnerability assessment data is evaluated to predict host devices and user identifiers of the network demonstrating a risk of vulnerability to stored data of the plurality of storage devices. A list is generated of the host devices and the user identifiers of the network demonstrating a risk of vulnerability to the stored data of the plurality of storage devices of the network.

Conventional vulnerability management solutions typically take a device-centric approach to vulnerability analysis, focusing on patching and otherwise remediating devices while disregarding user access to the underlying data as well as the relative importance and value of the stored data. The conventional solutions typically provide ordered lists of devices ranked according to critical vulnerabilities, such as known vulnerabilities in operating systems or applications of the network devices. Network administrators then undertake remediation of the devices, e.g., by patching and updating the operating systems to address the vulnerabilities. For large enterprises with several thousand devices, remediation is a persistent endeavor, and prioritization of the remediation is essential to protecting networks against attacks. However, the ordered lists of the conventional technology do not take into consideration the location and access of the underlying stored data itself, let alone the relative risk of users accessing the underlying data via particular devices. Today, data is rarely stored on host devices, but rather in centralized data storage platforms, such as network attached storage (NAS) devices. As such, conventional vulnerability management solutions fail to consider actual access or usage of stored data, and do not correlate access to important data when considering how to prioritize device remediation.

The described embodiments provide a data-centric approach to network vulnerability analysis, by taking into consideration the relative risk of users, via their user identifiers and the host devices they access, that have access to the stored data of a network. The described embodiments operate to protect important data from cyberthreats by prioritizing remediation of host devices and user identifiers used for accessing the important data by ensuring host devices, and the user identifiers accessing the data, are patched and the security configuration of hosts is hardened. By considering user identifiers that have access to, or actually access, the data that needs protection, the described embodiments reduce the time needed to remediate high risk hosts and keep them updated to ensure data is protected vs a device being protected. In some embodiments, data protection can be automated by utilizing artificial intelligence (AI) models trained to identify high risk host devices and user identifiers, thereby increasing the data protection by integrating threat detection with attack surface management. Moreover, in some embodiments, vulnerability reporting is combined with real time data protection, enabling an autonomous data protection solution that can operate without any human intervention.

Vulnerability assessment data including audit data is received for a plurality of storage devices of a network. The plurality of storage devices can be included within one or more network attached storage (NAS) devices that are communicatively coupled to a network. The audit data is a log of user activities pertaining to the NAS devices, includes time series data of accesses to the plurality of storage devices, where an access identifies a host device accessing the storage device of the plurality of storage devices, a user identifier of the host device accessing the storage device, and an operation performed by the host device during the access of the storage device. The audit data provides a connection between user identifiers that actually have access to the stored data of the NAS devices using the associated host devices, allowing for the identification of the user identifiers and host devices that have access to the stored data and/or do actually access the stored data.

It should be appreciated that the vulnerability assessment data can include many other types of data in addition to the audit data. In accordance with various embodiments, the additional data included as vulnerability assessment data can enhance and bolster the identification of host devices and user identifiers that demonstrate a risk of vulnerability to the stored data of the plurality of storage devices of the network. For example, and without limitation, the vulnerability assessment data can also include one or more of the following:
data identifying the open ports of the host devices;
the user identifiers and the host devices that have access to the server message blocks (SMBs) shares of the plurality of storage devices;
a permission percentage for the at least one SMB share, where the permission percentage includes a number of the user identifiers having access to the at least one SMB share divided by a number of the user identifiers that accessed the at least one SMB share;
a list of host devices of the network used for accessing at least one storage device of the plurality of storage devices and a list of user identifiers with access to at least one storage device of the plurality of storage devices;
an intersection of the host devices and the user identifiers;
user permission information for the plurality of storage devices;
identification of instances of the stored data comprising high value data;
device inventory data for the host devices, the device inventory data including a version and patch level of an operating system for the host devices;
device inventory data including applications and versions of applications installed on the host devices; and
transmission control protocol (TCP) session states for the host devices and the user identifiers.

It should be appreciated that the vulnerability assessment data can include any type of data useful for identifying a relative risk of user identifiers and host devices for accessing stored data of a network.

The vulnerability assessment data is evaluated to predict host devices and user identifiers of the network demonstrating a risk of vulnerability to stored data of the plurality of storage devices. In some embodiments, a dataset based at least on the vulnerability assessment data is generated for use by an artificial intelligence (AI) model for predicting host devices of the network demonstrating a risk of vulnerability to the plurality of storage devices of the network. In some embodiments, the vulnerability assessment data of the dataset is labelled and weighted, wherein weights applied to instances of the vulnerability assessment data represent a relative risk score of the instances of the vulnerability assessment data.

In some embodiments, the dataset is input into the AI model for predicting host devices and the user identifiers of the network demonstrating a risk of vulnerability to the plurality of storage devices of the network using the dataset. The host devices and the user identifiers of the network demonstrating a risk of vulnerability to the plurality of storage devices of the network are predicted using the dataset at the AI model. In some embodiments, the AI model is trained for predicting host devices and the user identifiers of the network demonstrating a risk of vulnerability to the plurality of storage devices of the network using the dataset.

A list is generated of the host devices and the user identifiers of the network demonstrating a risk of vulnerability to the stored data of the plurality of storage devices of the network. In some embodiments, a list of high risk host devices is generated, where compromise of a high risk host device would expose the stored data. In some embodiments, a list of high risk user identifiers is generated, where a high risk user has access to high valued data and/or a high volume of data. In some embodiments, the list of host devices and user identifiers is a combined list of the high risk host devices and high risk user identifiers.

Providing vulnerability assessments for a network including a plurality of storage devices that considers user identifiers and host devices that have access to the underlying data, in accordance with the described embodiments, improves the performance of vulnerability assessment over conventional solutions. Hence, the embodiments of the present invention greatly extend beyond conventional methods of vulnerability assessments of networks. Moreover, embodiments of the present invention amount to significantly more than merely using a computer to perform vulnerability assessments of networks. Instead, embodiments of the present invention specifically recite a novel process, rooted in computer technology, utilizing a combination of user identifiers and host devices to identify user identifiers and host devices that demonstrate a risk of vulnerability to the stored data of the plurality of storage devices of the network.

### Example System for Vulnerability Assessment of a Network Including Storage Devices

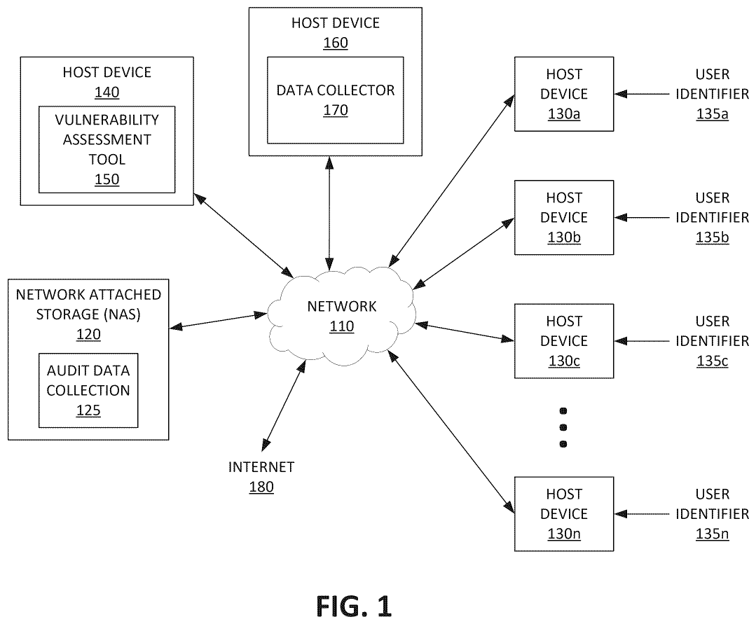

FIG. 1 is a block diagram illustrating an example network 110 including a vulnerability assessment tool 150, in accordance with various embodiments. In accordance with the described embodiments, vulnerability assessment tool 150 is configured to perform a vulnerability assessment for identifying host devices 130a-130n and user identifiers 135a-135n of network 110 demonstrating a risk of vulnerability to the stored data of NAS 120. Network 110 includes NAS 120, host devices 130a-130n, host device 140, and host device 160. In some embodiments, network 110 is communicatively coupled to the Internet 180. It should be appreciated that network 110 can include any number of host devices 130a-130n, 140, and 160, and any number of NAS 120 devices. Moreover, it should be appreciated that NAS 120, host devices 130a-130n, host device 140, and host device 160, can be standalone computing and/or storage devices (e.g., computer system 600) or can be distributed over multiple components (e.g., a virtualization infrastructure or a cloud-based infrastructure). In some embodiments, network 110 is comprised within or is an enterprise system.

Host devices 130a-130n (individually referred to herein as a host device 130) provide access to data stored within NAS 120. Users associated with user identifiers 135a-130n (individually referred to herein as a user identifier 135) use host devices 130a-130n, respectively, to access the data stored within NAS 120. It should be appreciated that host devices 130a-130n and user identifiers 135a-130n might have different permissions and roles for accessing different data stored within NAS 120. For example, a user identifier 135 associated with a finance position within an enterprise might have access to different data of NAS 120 than a user identifier 135 associated with a marketing position.

NAS 120 provides data storage for network 110. NAS 120 includes audit data collection module 125 that is configured to collect audit data according to data accesses of data stored at NAS 120. The audit data includes time series data of accesses to the data stored at NAS 120, where an access event identifies the data accessed at NAS 120, a host device (e.g., host device 130) accessing NAS 120, a user identifier (e.g., user identifier 135) accessing NAS 120, and an operation (e.g., a data read or a data write) performed by the host device during the access event. The audit data for an access event can also include the data path of the data accessed and a time stamp. Audit data collection module 125 collects and maintains audit data of access events, such that the audit data can be accessed by other services and applications, such as vulnerability assessment tool 150.

Network 110 also includes at least one host device 140 including vulnerability assessment tool 150. Vulnerability assessment tool 150 is configured to receive collected data (also referred to herein as “vulnerability assessment data”) for determining host devices 130a-n and user identifiers 135a-n that demonstrate a risk of vulnerability to the data stored at NAS 120.

In some embodiments, network 110 also includes at least one host device 160 including at least one data collector 170 for collecting data for use by vulnerability assessment tool 150. The data collected by data collector 170 can enhance and bolster the identification of host devices and user identifiers that demonstrate a risk of vulnerability to the stored data of NAS 120.

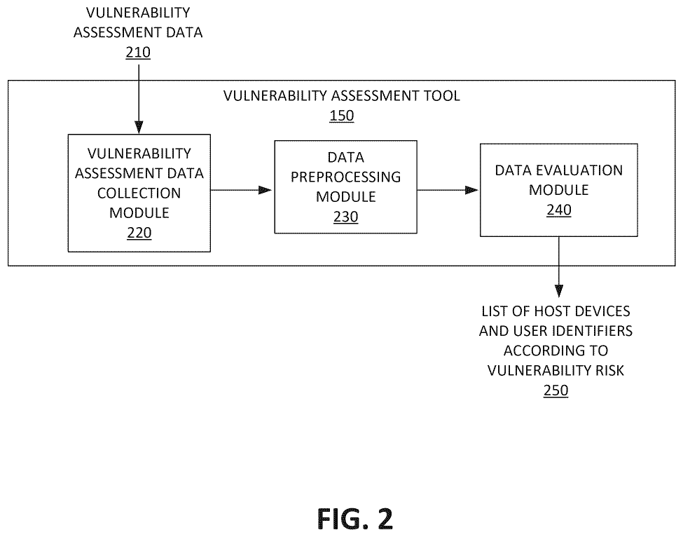

FIG. 2 is a block diagram illustrating a vulnerability assessment tool 150, in accordance with various embodiments. Vulnerability assessment tool 150 includes vulnerability assessment data collection module 220, data preprocessing module 230, and data evaluation module 240. It should be appreciated that vulnerability assessment data collection module 220, data preprocessing module 230, and data evaluation module 240, can be under the control of a single component of an enterprise computing environment (e.g., a distributed computer system, host device 140, or computer system 600) or can be distributed over multiple components (e.g., a virtualization infrastructure or a cloud-based infrastructure). Vulnerability assessment tool 150 is configured to generate a list 250 of host devices and user identifiers according to vulnerability risk.

Vulnerability assessment data collection module 220 receives vulnerability assessment data 210, including audit data for storage devices of a network (e.g., audit data from audit data collection module 125). It should be appreciated that vulnerability assessment data can include any type of data useful for identifying a relative risk of user identifiers and host devices for accessing stored data of a network. In some embodiments, vulnerability assessment data 210 includes data collected by one or more data collectors 170.

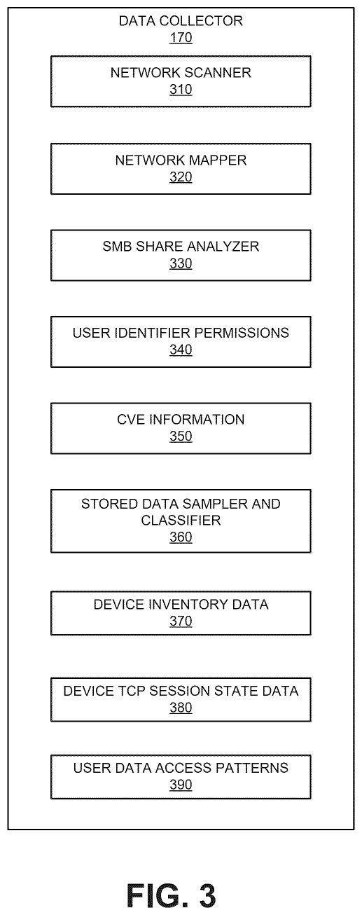

With reference to FIG. 3, a block diagram of an example data collector 170 is illustrated, in accordance with various embodiments. Data collector 170 includes at least one of the following modules: network scanner 310, network mapper 320, server message blocks (SMB) share analyzer 330, user identifier permissions 340, common vulnerabilities and exposure (CVE) information 350, stored data sampler and classifier 360, device inventory data 370, device transmission control protocol (TCP) session state data 380, and user data access patterns 390. It should be appreciated that a data collector 170 can include one or more of these modules, such there can be separate data collectors 170 each implementing one or more of these modules or a data collector 170 can implement a combination of the described modules. It should be further appreciated that other types of modules in addition to those described can be implemented to provide additional information that can inform vulnerability assessments of user identifiers and host devices of a network.

Network scanner 310 is configured to perform a scan of host devices of the network for identifying open ports of the host devices of the network. The information on open ports of the host devices of the network can be included within vulnerability assessment data 210 provided to vulnerability assessment tool 150.

Network mapper 320 is configured to map user identifiers and host devices of the network having access to at least one storage device of the network. The map user identifiers and host devices of the network can be included within vulnerability assessment data 210 provided to vulnerability assessment tool 150.

SMB share analyzer 330 is configured to determine SMB shares of storage devices of the network based at least in part on a mapping of the network (e.g., as performed at network mapper 320. The user identifiers and the host devices that have access to the SMB shares of the storage devices is determined by SMB share analyzer. The user identifiers and host devices that have access to the SMB shares of the storage devices can be included within vulnerability assessment data 210 provided to vulnerability assessment tool 150.

User identifier permissions 340 are collected at data collector 170. User identifier permission 340 includes information on the data access permissions afforded to the user identifiers of the network. User identifiers permissions 340 can be included within vulnerability assessment data 210 provided to vulnerability assessment tool 150.

CVE information 350 is collected at data collector 170. CVE information 350 includes publicly disclosed cybersecurity vulnerabilities that are typically evaluated according to a threat level. CVE information 350 can be included within vulnerability assessment data 210 provided to vulnerability assessment tool 150.

Stored data sampler and classifier 360 is configured to sample stored data that is accessed during access events of the storage devices. Stored data sampler and classifier 360 is configured to classify sampled instances of the stored data to determine whether the sampled instances of the stored data includes high value data. For example, a parsing engine can be used to sample and classify the stored data. Instances of the stored data including high value data can be included within vulnerability assessment data 210 provided to vulnerability assessment tool 150.

Device inventory data 370 for the host devices can be collected at data collector 170, where device inventory data 370 includes a version and patch level of an operating system for the host devices. In some embodiments, data device inventory 370 also includes applications and versions of applications installed on the host devices. Device inventory data 370 can be included within vulnerability assessment data 210 provided to vulnerability assessment tool 150.

Device TCP session state data 380 can be collected at data collector 170, where device TCP session state data 380 includes information on open TCP sessions between host devices of the network. Device TCP session state data 380 can be included within vulnerability assessment data 210 provided to vulnerability assessment tool 150.

User data access patterns 390 can be collected at data collector 170, where user data access patterns 390 includes information on typical user data access patterns for user identifiers of the network. In some embodiments, user data access patterns 390 is configured to analyze the user data access patterns to identify anomalous user data access patterns that deviates from the normal behavior associated with a user identifier. Data access patterns that deviate from normal behavior is indicative of a cyber-attack, such as data exfiltration or data damage. User data access patterns 390, including anomalous user data access pattern indicators, can be included within vulnerability assessment data 210 provided to vulnerability assessment tool 150.

With reference to FIG. 2, vulnerability assessment data 210 received at vulnerability assessment data collection module 220 is forwarded to data preprocessing module 230.

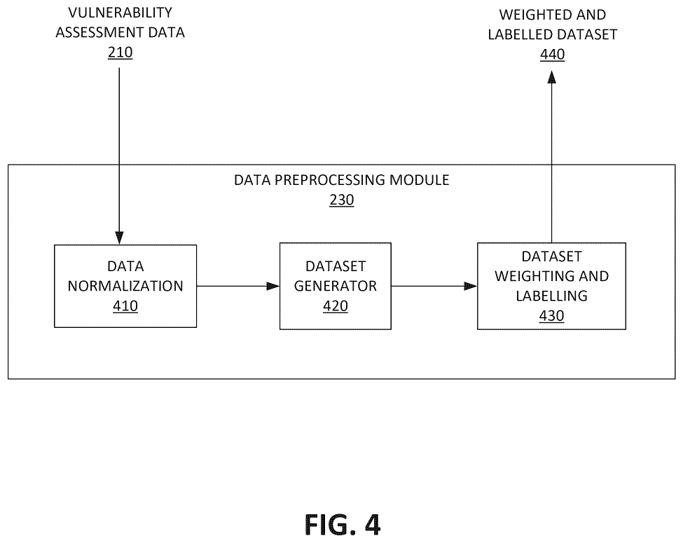

FIG. 4 is a block diagram illustrating data preprocessing module 230 of vulnerability assessment tool 150, in accordance with various embodiments. Data preprocessing module 230 is configured to process vulnerability assessment data 210 for ingestion by an artificial intelligence (AI) model. It should be appreciated that vulnerability assessment data 210 may be received in multiple different data formats and types of data (e.g., user data, computer data, metadata), and data preprocessing module 230 may perform data normalization on vulnerability assessment data 210 at data normalization module 410 to prepare vulnerability assessment data 210 for ingestion by the AI model.

At dataset generator module 420, data preprocessing module 230 encodes vulnerability assessment data 210 into a dataset for processing by the AI model. Data preprocessing module 230 is also configured to label vulnerability assessment data 210 of the dataset and weight vulnerability assessment data 210 of the dataset for use by the AI model at dataset weighting and labelling module 430 to generate weighted and labelled dataset 440. The weights applied to instance of vulnerability assessment data 210 represent a relative risk score of the instances of the vulnerability assessment data. For example, data preprocessing module 230 may apply higher weights (e.g., a higher vulnerability risk) to user identifiers demonstrating anomalous data access patterns than user identifiers that have access to stored data. It should be appreciated that weighting of vulnerability assessment data 210 may be externally controlled (e.g., by human network administrators) and may dynamically adapted.

With reference to FIG. 2, data evaluation module 240 receives the preprocessed vulnerability assessment data 210 from data preprocessing module 230. In some embodiments, the preprocessed vulnerability assessment data 210 is a dataset encoded for use by an AI model (e.g., weighted and labelled dataset 440).

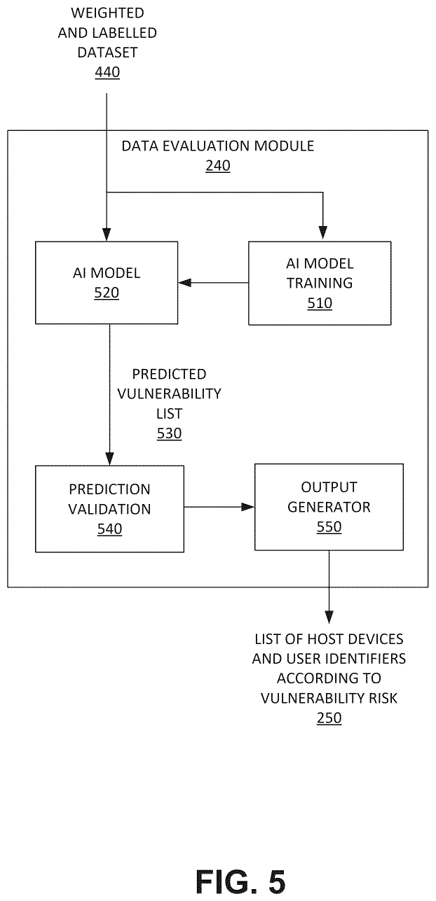

FIG. 5 is a block diagram illustrating data evaluation module 240 of vulnerability assessment tool 150, in accordance with various embodiments. Weighted and labelled dataset 440 is received at AI model 520. AI model 520 is trained to predict host devices and user identifiers of the network demonstrating a risk of vulnerability to the plurality of storage devices of the network. AI model 520 analyzes weighted and labelled dataset 440 and generates a predicted vulnerability list 530 of host devices and user identifiers of the network demonstrating a risk of vulnerability to the plurality of storage devices of the network.

In some embodiments, weighted and labelled dataset 440 is received at AI model training module 510 for training AI model 520 to predict host devices and user identifiers of the network demonstrating a risk of vulnerability to the plurality of storage devices of the network. In some embodiments, AI model training module 510 is used to fine tune AI model 520.

In some embodiments, prediction validation module 540 receives predicted vulnerability list 530 and performs a model assessment operation to validate the results.

Output generator 550 is configured to generate list 250 of host devices and user identifiers according to vulnerability risk based at least in part of predicted vulnerability list 530. List 250 includes the host devices and the user identifiers of the network demonstrating a risk of vulnerability to the stored data of the storage devices of the network. In some embodiments, list 250 is an ordered list ranked according to the risk of vulnerability to the stored data of the storage devices of the network. In some embodiments, list 250 includes high risk host devices, where compromise of a high risk host device would expose the stored data. In some embodiments, list 250 includes high risk user identifiers, where a high risk user has access to high valued data and/or a high volume of data. In some embodiments, list 250 includes a combined list of the high risk host devices and high risk user identifiers.

It should be appreciated that list 250 may be exported to and/or utilized by other vulnerability assessment or remediation tools, supplementing the determination of vulnerable host devices for remediation. For example, list 250 may be used to generate alerts to security administrators of high risk host devices and user identifiers for expedited remediation operations or to execute a third party vulnerability scanner to ensure that high risk host devices and user identifiers are patched and have hardened security configurations.

In some embodiments, security administrators may interact with list 250 directly to effectuate security actions. These actions allow security administrators to take immediate action if a host device or user identifier is identified as high risk, and allows for protection of data while providing time to remediate the host device or user identifier. Actions available to the security administrators can include, without limitation: disabling active directory accounts associated with a user identifier; revoking permissions to a user identifier and/or host device to block access to data; and integrating with an endpoint protection tool that enable host device isolation (e.g., detaching the host device from the network and placing a host device placing the host device in quarantine).

### Example Computer System

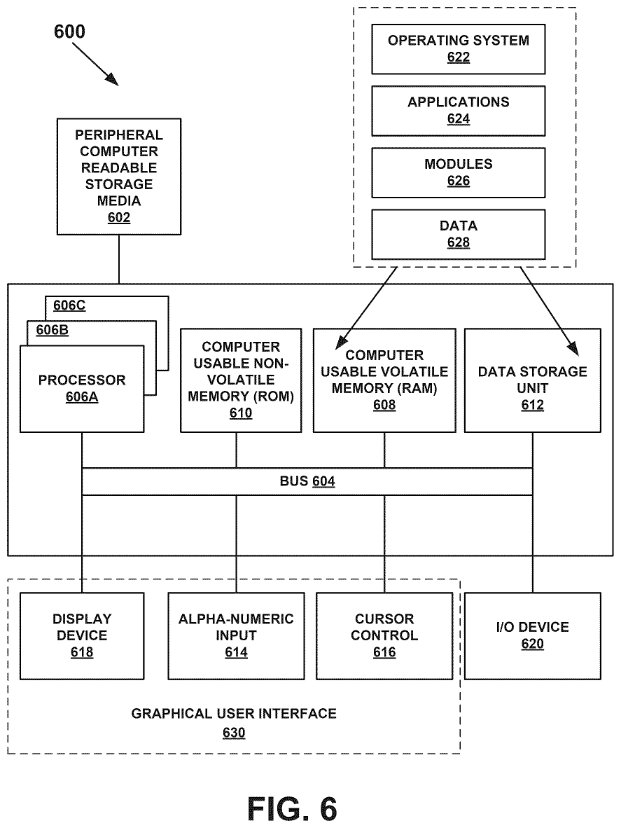

FIG. 6 is a block diagram of an example computer system 600 upon which embodiments of the present invention can be implemented. FIG. 6 illustrates one example of a type of computer system 600 (e.g., a computer system) that can be used in accordance with or to implement various embodiments which are discussed herein.

It is appreciated that computer system 600 of FIG. 6 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 600 of FIG. 6 is well adapted to having peripheral tangible computer-readable storage media 602 such as, for example, an electronic flash memory data storage device, a floppy disc, a compact disc, digital versatile disc, other disc-based storage, universal serial bus “thumb” drive, removable memory card, and the like coupled thereto. The tangible computer-readable storage media is non-transitory in nature.

Computer system 600 of FIG. 6 includes an address/data bus 604 for communicating information, and a processor 606A coupled with bus 604 for processing information and instructions. As depicted in FIG. 6, computer system 600 is also well suited to a multi-processor environment in which a plurality of processors 606A, 606B, and 606C are present. Conversely, computer system 600 is also well suited to having a single processor such as, for example, processor 606A. Processors 606A, 606B, and 606C may be any of various types of microprocessors. Computer system 600 also includes data storage features such as a computer usable volatile memory 608, e.g., random access memory (RAM), coupled with bus 604 for storing information and instructions for processors 606A, 606B, and 606C. Computer system 600 also includes computer usable non-volatile memory 610, e.g., read only memory (ROM), coupled with bus 604 for storing static information and instructions for processors 606A, 606B, and 606C. Also present in computer system 600 is a data storage unit 612 (e.g., a magnetic or optical disc and disc drive) coupled with bus 604 for storing information and instructions. Computer system 600 also includes an alphanumeric input device 614 including alphanumeric and function keys coupled with bus 604 for communicating information and command selections to processor 606A or processors 606A, 606B, and 606C. Computer system 600 also includes a cursor control device 616 coupled with bus 604 for communicating user input information and command selections to processor 606A or processors 606A, 606B, and 606C. In one embodiment, computer system 600 also includes a display device 618 coupled with bus 604 for displaying information.

Referring still to FIG. 6, display device 618 of FIG. 6 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 616 allows the computer user to dynamically signal the movement of a visible symbol (cursor) on a display screen of display device 618 and indicate user selections of selectable items displayed on display device 618. Many implementations of cursor control device 616 are known in the art including a trackball, mouse, touch pad, touch screen, joystick or special keys on alphanumeric input device 614 capable of signaling movement of a given direction or manner of displacement. Alternatively, it will be appreciated that a cursor can be directed and/or activated via input from alphanumeric input device 614 using special keys and key sequence commands. Computer system 600 is also well suited to having a cursor directed by other means such as, for example, voice commands. In various embodiments, alphanumeric input device 614, cursor control device 616, and display device 618, or any combination thereof (e.g., user interface selection devices), may collectively operate to provide a graphical user interface (GUI) 630 under the direction of a processor (e.g., processor 606A or processors 606A, 606B, and 606C). GUI 630 allows user to interact with computer system 600 through graphical representations presented on display device 618 by interacting with alphanumeric input device 614 and/or cursor control device 616.

Computer system 600 also includes an I/O device 620 for coupling computer system 600 with external entities. For example, in one embodiment, I/O device 620 is a modem for enabling wired or wireless communications between computer system 600 and an external network such as, but not limited to, the Internet. In one embodiment, I/O device 620 includes a transmitter. Computer system 600 may communicate with a network by transmitting data via I/O device 620.

Referring still to FIG. 6, various other components are depicted for computer system 600. Specifically, when present, an operating system 622, applications 624, modules 626, and data 628 are shown as typically residing in one or some combination of computer usable volatile memory 608 (e.g., RAM), computer usable non-volatile memory 610 (e.g., ROM), and data storage unit 612. In some embodiments, all or portions of various embodiments described herein are stored, for example, as an application 624 and/or module 626 in memory locations within RAM 608, computer-readable storage media within data storage unit 612, peripheral computer-readable storage media 602, and/or other tangible computer-readable storage media.

### Example Methods of Operation

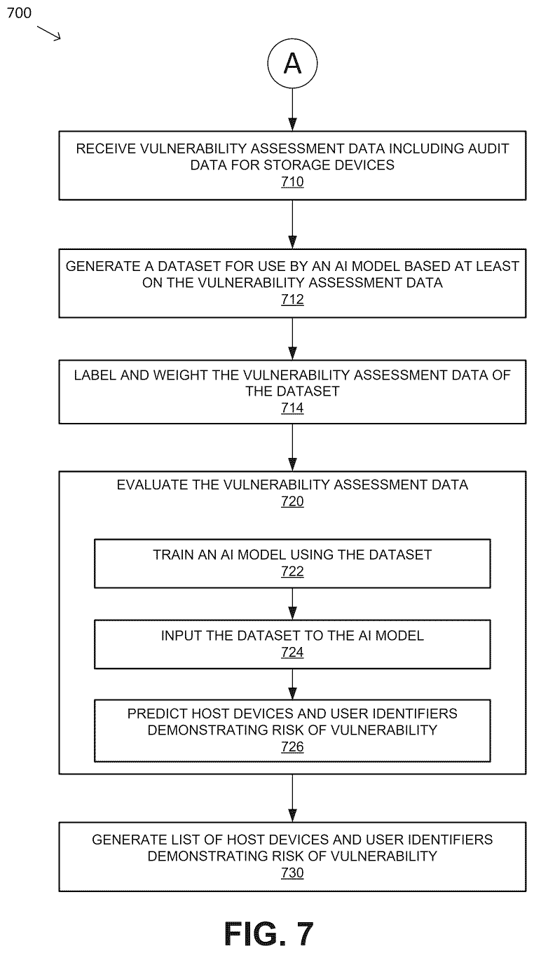

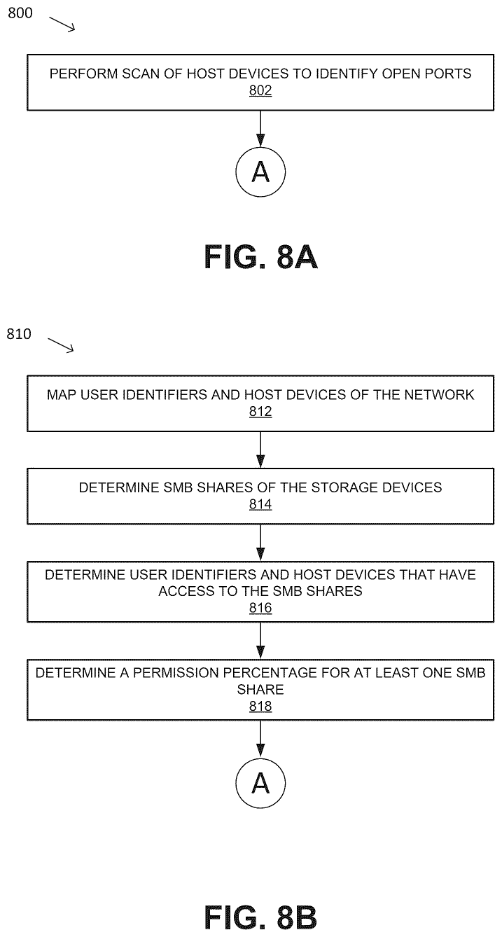

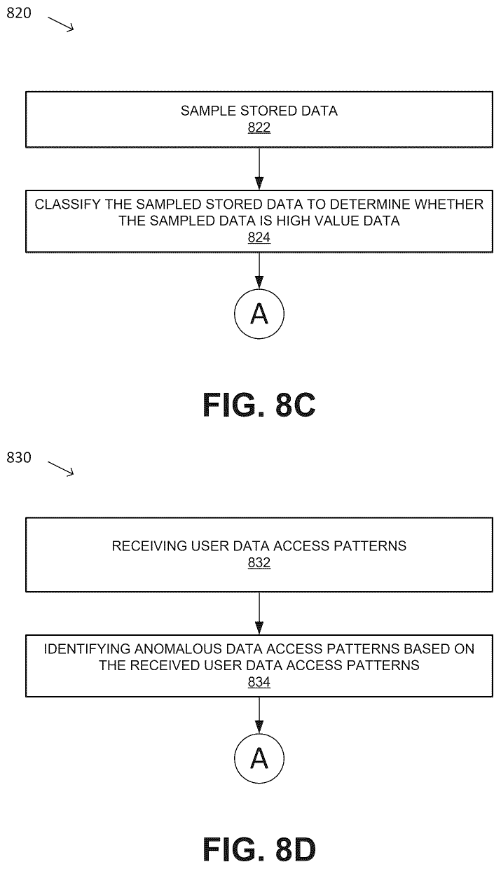

The following discussion sets forth in detail the operation of some example methods of operation of embodiments. With reference to FIGS. 7 through 8D, flow diagrams 700, 800, 810, 820, and 830 illustrate example procedures used by various embodiments. The flow diagrams 700, 800, 810, 820, and 830 include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 600). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in flow diagrams 700, 800, 810, 820, and 830 may be performed in an order different than presented and/or not all of the procedures described in flow diagrams 700, 800, 810, 820, and 830 may be performed. It is further appreciated that procedures described in flow diagrams 700, 800, 810, 820, and 830 may be implemented in hardware, or a combination of hardware with firmware and/or software provided by computer system 600.

At procedure 710 of flow diagram 700, vulnerability assessment data including audit data is received for a plurality of storage devices of a network. The audit data includes time series data of access events to the plurality of storage devices, an access event identifying a host device accessing the storage device of the plurality of storage devices, a user identifier of the host device accessing the storage device, and an operation performed by the host device during the access of the storage device.

It should be appreciated that the vulnerability assessment data can include any type of data useful for identifying a relative risk of user identifiers and host devices for accessing stored data of a network. In some embodiments, the vulnerability assessment data includes a list of host devices of the network used for accessing at least one storage device of the plurality of storage devices and a list of user identifiers with access to at least one storage device of the plurality of storage devices. In some embodiments, the vulnerability assessment data further includes an intersection of the host devices and the user identifiers. In some embodiments, the vulnerability assessment data includes user permission information for the plurality of storage devices. In some embodiments, the vulnerability assessment data includes device inventory data for the host devices, where the device inventory data includes a version and patch level of an operating system for the host devices. In some embodiments, the device inventory data further includes applications and versions of applications installed on the host devices. In some embodiments, wherein the vulnerability assessment data further includes transmission control protocol (TCP) session states for the host devices and the user identifiers.

FIGS. 8A, 8B, 8C, and 8D are flow diagrams 800, 810, 820, and 830, respectively, for processes for determining various types of vulnerability assessment data, according to various embodiments. The outputs of flow diagrams 800, 810, 820, and 830 can be included in the vulnerability assessment data received at procedure 710 of FIG. 7, either separately or in combination.

With reference to FIG. 8A, at procedure 802 of flow diagram 800, a scan of host devices of the network is performed, the scan identifying open ports of the host devices of the network. The output of the scan, the identified open ports of the host devices, is included within the vulnerability assessment data received at procedure 710 of FIG. 7.

With reference to FIG. 8B, at procedure 812 of flow diagram 810, user identifiers and host devices of the network having access to at least one storage device of the plurality of storage devices are mapped. In some embodiments, the mapping of the user identifiers and host devices of the network having access to at least one storage device of the plurality of storage devices can be included within the vulnerability assessment data received at procedure 710 of FIG. 7.

At procedure 814, in some embodiments, SMB shares of the plurality of storage devices is determined based at least in part on the mapping. At procedure 816, the user identifiers and the host devices that have access to the SMB shares of the plurality of storage devices is determined. In some embodiments, user identifiers and the host devices that have access to the SMB shares of the plurality of storage devices can be included within the vulnerability assessment data received at procedure 710 of FIG. 7.

In accordance with some embodiments, as shown at procedure 818, a permission percentage of access to at least one SMB share for at least one server SMB share is determined. The permission percentage includes the number of user identifiers having access to at least one SMB share divided by the number of user identifiers that accessed the at least one SMB share. The permission percentage for at least one SMB share can be included within the vulnerability assessment data received at procedure 710 of FIG. 7.

With reference to FIG. 8C, at procedure 822 of flow diagram 820, stored data accessed during the access events to the plurality of storage devices is sampled. At procedure 824, the sampled instances of the stored data are classified to determine whether the sampled instances of the stored data includes high value data. For example, a parsing engine can be used to sample and classify the stored data. The identification of high value data accessed can be included within the vulnerability assessment data received at procedure 710 of FIG. 7.

With reference to FIG. 8D, at procedure 832 of flow diagram 830, user data access patterns associated at least with the user identifiers that have accessed stored data of at least one storage device of the plurality of storage devices are received. In some embodiments, the user access patterns can be included within the vulnerability assessment data received at procedure 710 of FIG. 7. At procedure 834, anomalous data access patterns of the stored data for at least one user identifier are identified based on the user access patterns, where the anomalous data access indicates a deviation from normal data access patterns by at least one user identifier. The anomalous user access patterns can be included within the vulnerability assessment data received at procedure 710 of FIG. 7

With reference to FIG. 7, in some embodiments, as shown at procedure 712, a dataset based at least on the vulnerability assessment data is generated for use by an artificial intelligence model for predicting host devices of the network demonstrating a risk of vulnerability to the plurality of storage devices of the network. In some embodiments, as shown at procedure 714, the vulnerability assessment data of the dataset is labeled and weighted, wherein weights applied to instances of the vulnerability assessment data represent a relative risk score of the instances of the vulnerability assessment data.

At procedure 720, the vulnerability assessment data is evaluated to predict host devices and user identifiers of the network demonstrating a risk of vulnerability to stored data of the plurality of storage devices. In some embodiments, as shown at procedure 722, the artificial intelligence model for predicting host devices and the user identifiers of the network demonstrating a risk of vulnerability to the plurality of storage devices of the network is trained using the dataset. In some embodiments, as shown at procedure 724, the dataset is input to the artificial intelligence model for predicting host devices and the user identifiers of the network demonstrating a risk of vulnerability to the plurality of storage devices of the network using the dataset. At procedure 726, the host devices and the user identifiers of the network demonstrating a risk of vulnerability to the plurality of storage devices of the network are predicted using the dataset at the artificial intelligence model.

At procedure 730, a list is generated of the host devices and the user identifiers of the network demonstrating a risk of vulnerability to the stored data of the plurality of storage devices of the network.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A computer implemented method of vulnerability assessment within a network, the method comprising:
receiving vulnerability assessment data comprising audit data for a plurality of storage devices of a network, the audit data comprising time series data of access events to the plurality of storage devices of the network, an access event identifying a host device accessing the storage device of the plurality of storage devices, a user identifier of the host device accessing the storage device, and an operation performed by the host device during the access event of the storage device;
evaluating the vulnerability assessment data to predict host devices and user identifiers of the network demonstrating a risk of vulnerability to stored data of the plurality of storage devices of the network; and
generating a list of the host devices and the user identifiers of the network demonstrating a risk of vulnerability to the stored data of the plurality of storage devices of the network.

2. The method of claim 1, further comprising:
generating a dataset based at least on the vulnerability assessment data for use by an artificial intelligence model for predicting host devices of the network demonstrating a risk of vulnerability to the plurality of storage devices of the network.

3. The method of claim 2, further comprising:
labelling and weighting the vulnerability assessment data of the dataset, wherein weights applied to instances of the vulnerability assessment data represent a relative risk score of the instances of the vulnerability assessment data.

4. The method of claim 3, wherein the evaluating the vulnerability assessment data to predict host devices and user identifiers of the network demonstrating a risk of vulnerability to the plurality of storage devices of the network comprises:
inputting the dataset to the artificial intelligence model for predicting host devices and the user identifiers of the network demonstrating a risk of vulnerability to the plurality of storage devices of the network using the dataset; and
predicting the host devices and the user identifiers of the network demonstrating a risk of vulnerability to the plurality of storage devices of the network using the dataset at the artificial intelligence model.

5. The method of claim 4, wherein the evaluating the vulnerability assessment data to predict host devices and user identifiers of the network demonstrating a risk of vulnerability to the plurality of storage devices of the network comprises:
training the artificial intelligence model for predicting host devices and the user identifiers of the network demonstrating a risk of vulnerability to the plurality of storage devices of the network using the dataset.

6. The method of claim 1, further comprising:
performing a scan of host devices of the network, the scan identifying open ports of the host devices of the network, such that the vulnerability assessment data comprises the open ports of the host devices.

7. The method of claim 1, further comprising:
mapping user identifiers and host devices of the network having access to at least one storage device of the plurality of storage devices.

8. The method of claim 7, further comprising:
determining server message block (SMB) shares of the plurality of storage devices based at least in part on the mapping; and
determining the user identifiers and the host devices that have access to the SMB shares of the plurality of storage devices, such that the vulnerability assessment data further comprises the user identifiers and the host devices that have access to the SMB shares of the plurality of storage devices.

9. The method of claim 8, further comprising:
determining, for at least one server message block (SMB) share of the plurality of SMB shares, a permission percentage of access to the at least one SMB share, wherein the permission percentage comprises a number of the user identifiers having access to the at least one SMB share divided by a number of the user identifiers that accessed the at least one SMB share, such that the vulnerability assessment data further comprises the permission percentage for the at least one SMB share.

10. The method of claim 1, wherein the vulnerability assessment data further comprises a list of host devices of the network used for accessing at least one storage device of the plurality of storage devices and a list of user identifiers with access to at least one storage device of the plurality of storage devices.

11. The method of claim 10, wherein the vulnerability assessment data further comprises an intersection of the host devices and the user identifiers.

12. The method of claim 1, wherein the vulnerability assessment data further comprises user permission information for the plurality of storage devices.

13. The method of claim 1, wherein the vulnerability assessment data further comprises user data access patterns associated at least with the user identifiers that have accessed stored data of at least one storage device of the plurality of storage devices.

14. The method of claim 13, wherein the user data access patterns identifies anomalous data access patterns of the stored data for at least one user identifier, where the anomalous data access indicates a deviation from normal data access patterns by at least one user identifier.

15. The method of claim 1, further comprising:
sampling stored data accessed during the access events to the plurality of storage devices; and
classifying sampled instances of the stored data to determine whether the sampled instances of the stored data comprises high value data, such that the vulnerability assessment data comprises identification of instances of the stored data comprising high value data.

16. The method of claim 1, wherein the vulnerability assessment data further comprises device inventory data for the host devices, the device inventory data comprising a version and patch level of an operating system for the host devices.

17. The method of claim 16, wherein the device inventory data further comprises applications and versions of applications installed on the host devices.

18. The method of claim 1, wherein the vulnerability assessment data further comprises transmission control protocol (TCP) session states for the host devices and the user identifiers.

19. A non-transitory computer readable storage medium having computer readable program code stored thereon for causing a computer system to perform a method of vulnerability assessment within a network, the method comprising:
receiving vulnerability assessment data comprising audit data for a plurality of storage devices of a network, the audit data comprising time series data of access events to the plurality of storage devices of the network, an access event identifying a host device accessing the storage device of the plurality of storage devices, a user identifier of the host device accessing the storage device, and an operation performed by the host device during the access of the storage device;
generating a dataset based at least on the vulnerability assessment data for use in training an artificial intelligence model for predicting host devices of the network demonstrating a risk of vulnerability to the plurality of storage devices of the network;
evaluating the vulnerability assessment data to predict host devices and user identifiers of the network demonstrating a risk of vulnerability to stored data of the plurality of storage devices of the network, the evaluating comprising:
training the artificial intelligence model for predicting host devices and the user identifiers of the network demonstrating a risk of vulnerability to the plurality of storage devices of the network using the dataset; and
predicting the host devices and the user identifiers of the network demonstrating a risk of vulnerability to the plurality of storage devices of the network using the dataset; and
generating a list of the host devices and the user identifiers of the network demonstrating a risk of vulnerability to the stored data of the plurality of storage devices of the network.

20. The non-transitory computer readable storage medium of claim 19, the method further comprising:
labelling and weighting the vulnerability assessment data of the dataset, wherein weights applied to instances of the vulnerability assessment data represent a relative risk score of the instances of the vulnerability assessment data.
